(19) United States
(12) Patent Application Publication
(10) Pub. No.: US 2005/0149987 A1
(43) Pub. Date: Jul. 7, 2005

(54) Television viewing communities

(76) Inventors: Gilles Boccon-Gibod, Los Altos, CA (US); David Alan Bryan, Danbury, CT (US)

Correspondence Address: GOTTLIEB RACKMAN & REISMAN PC, 270 MADISON AVENUE, 8TH FLOOR, NEW YORK, NY, 100160601, US

(21) Appl. No.: 10/746,809

(22) Filed: Dec. 24, 2003

(51) Int. Cl. H04N 7/173; H04N 7/16

(52) U.S. Cl. 725/135

(57) ABSTRACT

Digital technology based consumer media devices have many desirable features, including the ability to easily find and watch television shows, and/or automatically record programs of interest. Disclosed is a system and method for allowing a group of television viewers to share program viewing information. This information, exchanged through various on-line community modalities (including Internet chat rooms, email, Internet Web Logs, and the like), can be used within a consumer media device to influence the decision process concerning which programs to record, buffer or view.

### RELATED APPLICATIONS

This application is related to the U.S. patent application Ser. No. ______, filed ______ entitled A METHOD AND APPARATUS FOR EXCHANGING PREFERENCES FOR REPLAYING A PROGRAM ON A PERSONAL VIDEO RECORDER, now ______ and incorporated by reference herein; and U.S. patent application Ser. No. ______, filed ______ entitled PERSONAL VIDEO RECORDERS WITH AUTOMATED BUFFERING now ______ incorporated herein by reference.

### FIELD OF THE INVENTION

The invention concerns a system and method to allow groups of television viewers (users) to form communities. The communities provide new sources of viewing recommendations and programming information for users who are members of the community.

### BACKGROUND OF THE INVENTION

Television distribution systems such as cable networks and satellites provide users with increasing numbers of television programs from which they can choose for viewing or recording. The advent of the Internet, and eventual use of the Internet to supply television-like programming, will further increase the amount of programming from which the user can choose.

The vast amount of programming available to users is both a blessing and a curse: it is a blessing to those whose interests and hobbies lend themselves to the many special interest programs and channels that are available, but a curse to those who have limited time to find and watch specific programs or entertainment that they may find useful and/or appealing. In many instances, these are the same individuals.

Because of their flexibility, advanced capabilities, and ease-of-use, digital technology based consumer media devices such as set-top boxes for cable and satellite television, Personal Video Recorders (PVRs) and Personal Computers (PCs) with television receiving and recording functionality have begun to provide an alternative to the traditional television and Video Cassette Recorder (VCR) as means for viewing and recording television programs in the home. These devices provide the ability to view and record programs of interest, both through user commands and programming as well as by “learning” user likes and dislikes (preferences).

In spite of their powerful features, these devices still have limitations in their ability to assist users in the selection of programs to view and record. Users can select programs based on title, channel, time of airing, as well as by favorite actor, actress, director, or through the use of other specific parameters. This can be extremely time consuming, requiring extensive effort on the part of the user.

As a result of the limitations of current digital consumer devices, users can frequently find that they have missed programming of interest to them. As an example, users can find themselves in chat rooms or involved in discussions on the Internet regarding a program that they have not seen or recorded.

For the foregoing reasons, there is a need for a method and system to share user viewing experiences including new viewing opportunities and program recording suggestions.

### SUMMARY OF THE INVENTION

The present system and method enhances the overall television user experience by facilitating the sharing of viewing experiences and suggestions regarding program viewing and recording. The sharing of experiences includes sharing of electronic lists created by other users as well as the use of recommendation lists published by user groups or critics. The lists contain at least one reference to a program or channel viewed on another television. In one embodiment, these lists (generated by individual users, critics, or formed through group interaction) appear in on-line magazines and newspapers. A user's television, PVR, set-top box, PC or other device accesses these lists through a network (e.g., the Internet) and, based upon recommendations (references) on the lists, selectively causes tuning to recommended programming. Recording of the recommended programming can also occur on an automated basis. In an alternate embodiment, e-mail is used to communicate the lists. In another embodiment, Internet Web-Logs (blogs) provide the references to the user's device, either through manual selection by the user, through automated retrieval by the device, or by automated transmission by a server hosting the blog. Other forms of electronic communication may also be used to share program recommendations.

An alternate embodiment of the system and method includes the use of a centralized server to learn about group preferences and to access blogs, e-mail, or other web sites containing recommendation lists. In this embodiment, the central server compiles recommendations and, based on the user's previously determined preferences, transmits recording preferences to the user's device. In this embodiment, monitoring of recommendation lists is performed by the centralized server rather than through the individual users' equipment. The centralized server may also receive e-mails with recommendations, and uses this information to provide viewing or recording references to the individual users' devices.

These and other features and objects of the invention will be more fully understood from the following detailed description of the embodiments, which should be read in light of the accompanying drawings.

In this regard, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description serve to explain the principles of the invention.

FIG. 1 illustrates a conventional PVR installed in a normal use;

FIG. 2 illustrates a PVR that is directly connected to the Internet;

FIG. 3 illustrates a PVR that is connected to the Internet through a secondary device;

FIG. 4 illustrates a community consisting of a group of PVR users;

FIG. 5 illustrates a possible web log (blog) that may be used to control a PVR;

FIG. 6 illustrates a chat room page that may be used to control a PVR; and

FIG. 7 illustrates an exemplary functional block diagram of a PVR that embodies the invention.

### DETAILED DESCRIPTION OF PREFERRED EMBODIMENTS OF THE INVENTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

In the below embodiments, we describe methods and systems that are realizable using digital technology based consumer media devices (CMDs). For clarity in describing the invention with reference to well known devices, and because certain embodiments include recording capability, we often refer to a personal video recorder or a “PVR” as an exemplary CMD. However, the ideas described herein should not be construed as limited to embodiments that require recording capability (or “PVR capability”). Any media viewing and/or recording device or set-top box with digitally-controllable tuning capability can be used to realize the functionality implied by many of the concepts described herein. Examples of such devices (all of which are to be considered CMDs herein) include set-top boxes for cable and satellite television, Personal Video Recorders (PVRs) and Personal Computers (PCs) with television receiving and/or recording functionality.

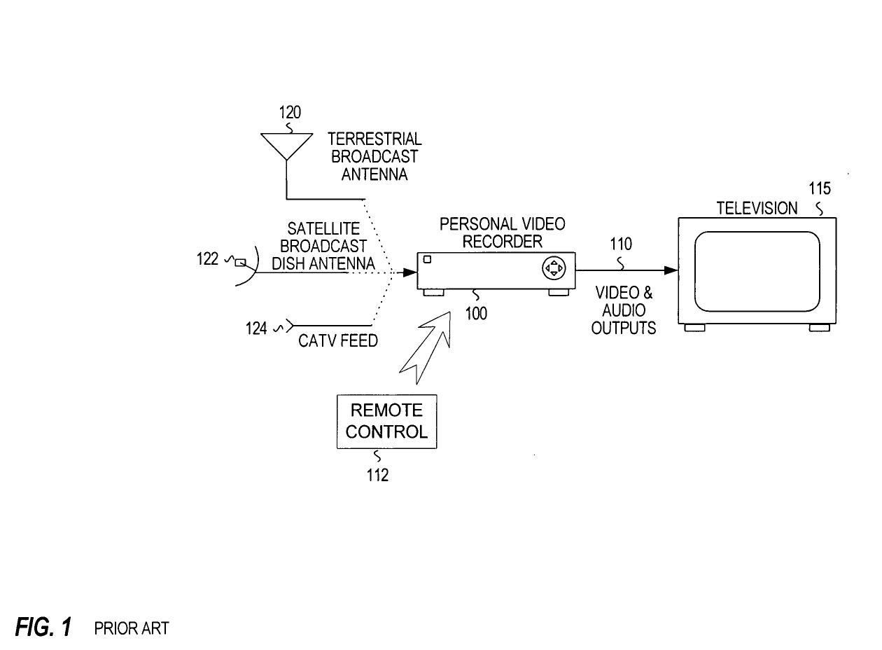

FIG. 1 shows a conventional PVR installation scenario. Personal video recorder 100 receives a broadcast signal from one or more sources of programming. The sources of programming may include terrestrial broadcast, satellite broadcast, and cable television (CATV). These sources of programming are received respectively by a terrestrial broadcast antenna 120, a satellite broadcast dish antenna 122, and a CATV feed 124. A source of programming comprises analog, digital or a combination of analog and digital programs. The video and audio outputs 110 of the personal video recorder 100 are connected to the television 115 for user viewing of programs from personal video recorder 100. The video and audio outputs 110 may also be connected to a recording device such as a conventional Video Cassette Recorder (VCR) or Digital Video Disc (DVD) recorder. Personal video recorder 100 also contains a telephone modem (not shown) that enables personal video recorder 100 to download program guide information and to allow the user to order programs through personal video recorder 100 using remote control 112. Generally, a telephone call is placed periodically to allow personal video recorder 100 to update program guide information. This enables personal video recorder 100 to automatically correct for changes in the programming scheduling. The telephone modem is also provided to allow the user to update the programming of the personal video recorder 100 directly from remote control 112. The user can also use remote control 112 and the program guide to select a “pay-per-view” program. “Pay-per-view” refers to a program that has a specific fee associated with viewing the program, including movies, concerts and sporting events. The telephone modem also allows the user to change his or her received programming. For example, a user might decide that he or she would like to receive Showtime Network, which is a network that viewers must pay to subscribe to. The user can select Showtime Network from the program guide and order the network, causing the information to be uploaded to the service provider from personal video recorder 100 by using the modem. The service provider then provides the specified channel(s) or program, updates the user's monthly bill, and bills the user for the new channel(s) or programs.

A conventional PVR can be set to record a particular program by one of four general methods. The first method resembles programming of a VCR. This method includes a user selecting a desired channel, date and time for recording. The PVR will simply record the selected channel at the selected time.

The second method of recording is performed by selecting a program through an on-screen menu. PVRs have a program guide that shows channels available for viewing and the programming that will be aired on the channels at a particular time. A user viewing the program guide may simply select a specific program that will air on a channel and press the record button (either on remote control 112 or personal video recorder 100). This guide contains programming information that is used to set the recording of personal video recorder 100. The programming information includes the date/time and the channel selected. This second method may also include selecting a program by the program title. Conventional PVRs enable the user to look up programs by designating a title name. Personal video recorder 100 will then display (on television 115) all upcoming episodes of programs having the designated title. The user can then elect to record a specific episode by selecting the episode and pressing the “record” button.

The third method includes scheduling an indicated program to automatically record throughout a season (or year). This may be called “a season pass”. A user indicates a desired program and indicates that he or she desires to record every episode. This selection is performed either through use of the programming guide or by designating a title, as previously described. This selection allows a user to record all upcoming episodes or only “new” episodes (i.e., does not include previously shown episodes that are repeated). Personal video recorder 100 will review the daily downloaded program information and will record the selected program. For example, a user may enjoy a particular series, such as “Everybody Loves Raymond”. The user could select “Everybody Loves Raymond” from the programming grid, and elect to record all new episodes. Personal video recorder 100 would automatically review the programming grid during the daily download, and record any new episodes of “Everybody Loves Raymond” that are aired.

The fourth method allows the PVR to select programs based upon a user's stored history. For example, if a user records several “police dramas”, this indicates that the user enjoys “police dramas” (i.e., dramas that deal with the investigation of crimes). Personal video recorder 100 will automatically record new programs that deal with investigating crimes.

Although four methods of selecting programs to record have been discussed, there are other techniques currently used. These include, but are not limited to, recording shows starring a particular actor or actress, or directed by a particular director. As will be appreciated by one skilled in the art, other methods and criteria can be used to cause recording to occur.

In addition to recording entire programs, PVRs may “buffer” channels or portions of programs as described in co-pending application “PERSONAL VIDEO RECORDERS WITH AUTOMATED BUFFERING”, incorporated herein by reference. This buffering process would typically anticipate which program a user will want to watch, and begin storing the program from its beginning, thereby allowing a user to watch a program in its entirety, despite the fact that they turn on the television some time after the start of the program.

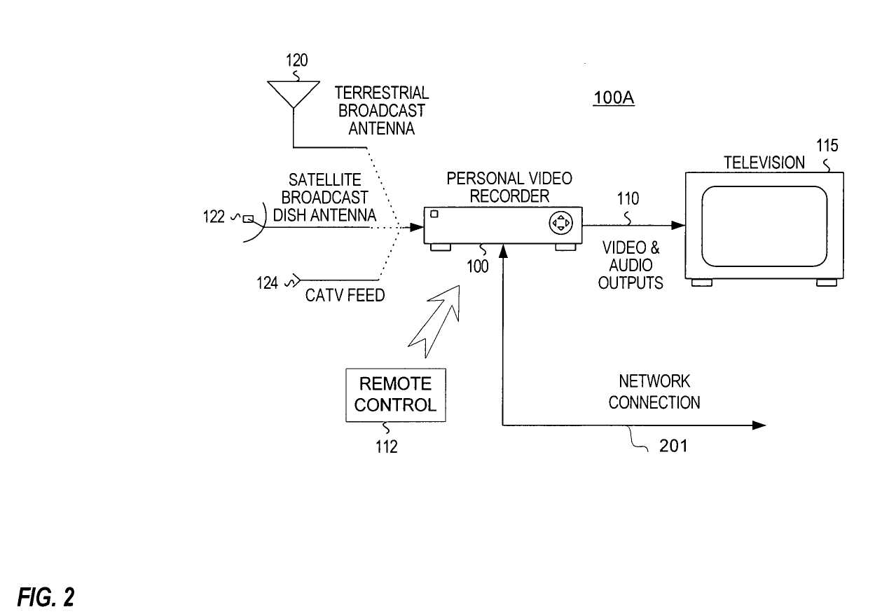

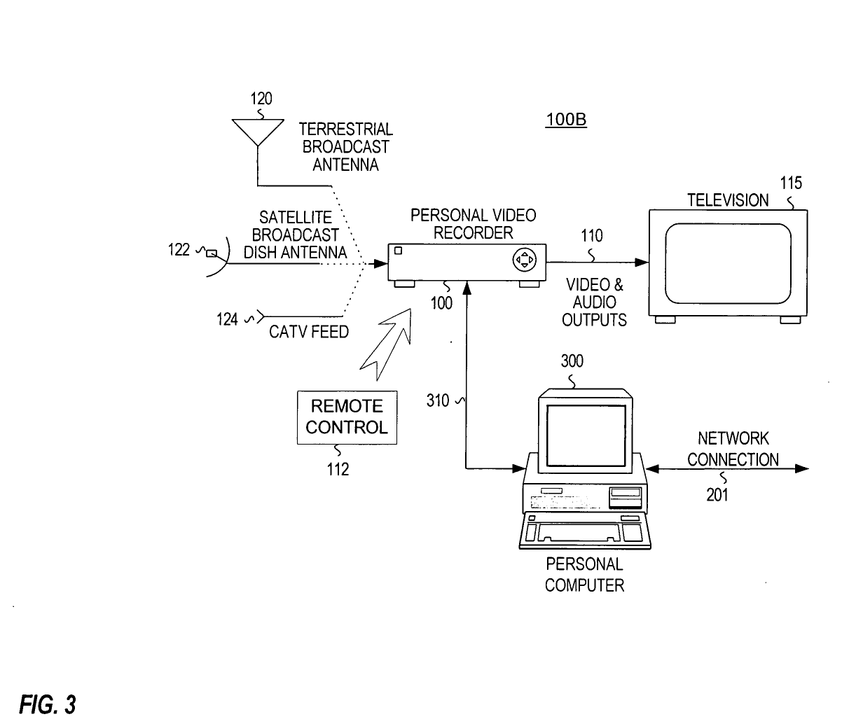

Personal video recorder 100A can be connected directly to the Internet through network connection 201, as illustrated in FIG. 2, or personal video recorder 100A can be connected to a personal computer 300, which in turn is connected to the Internet through a network connection 201, as illustrated in FIG. 3. Network connection 201 can be of any known form, including cable modem, wireless modem, Digital User Line (DSL), standard telephone line or a satellite. As will be appreciated by one skilled in the art, other methods of connecting to the Internet or can be used, such as wireless connections utilizing a notebook computer, Personal Digital Assistant (PDA), or a cellular phone.

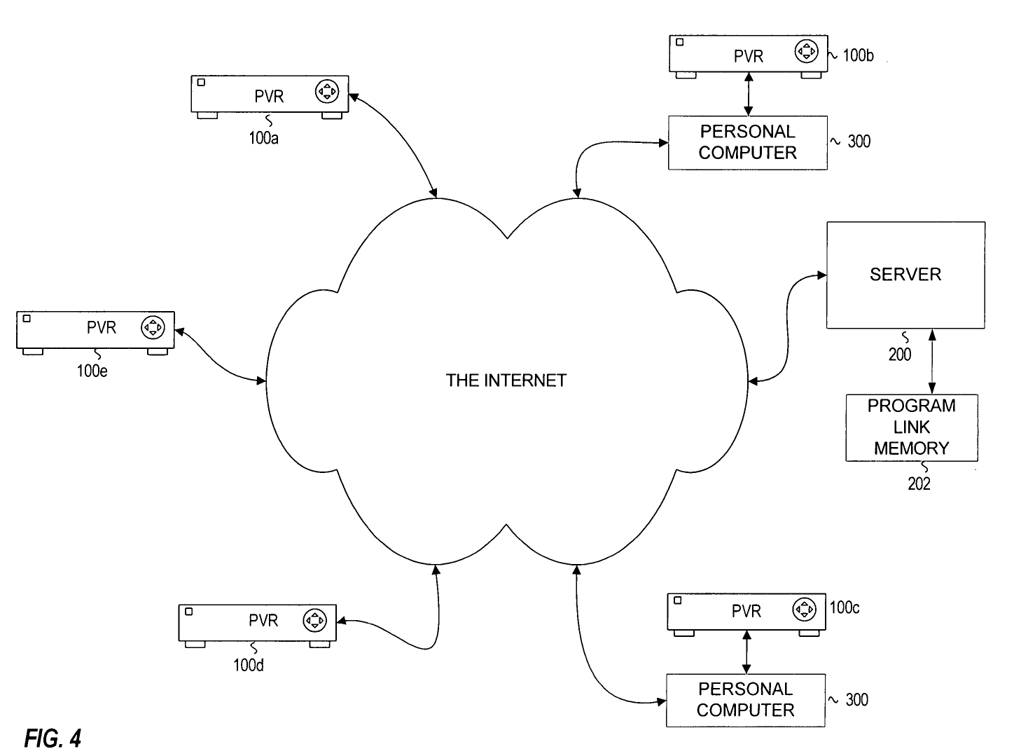

One example of a television viewing community, illustrated in FIG. 4, consists of a group of PVR users connected to the Internet who share experiences, provide various levels of technical and moral support to one another, and suggest/recommend programs to watch and record. Personal video recorders 100a-e can be directly connected to the Internet or connected to the Internet via a personal computer 300 through network connection 201. Members of the PVR community can “meet” and share information through modalities analogous to those used on the Internet today: chat rooms/instant messaging, email, and web logs (commonly called “blogs”). Information exchanged through various community modalities can be used within the respective personal video recorders to influence the decision process concerning which programs to record, buffer or view.

The following are scenarios that describe exemplary modes of sharing that can be used to enhance the television viewing and/or recording experience.

Chat Rooms/Instant Messaging/Email

In one embodiment, a CMD user joins a chat room that is either public or private and has one or more other CMD users. The chat “client” (software used by each user participating in the chat room) may run directly on a CMD that is directly connected to the Internet as illustrated in FIG. 2 (using the television screen as the text display), or may run on a personal computer attached to a CMD as illustrated in FIG. 3.

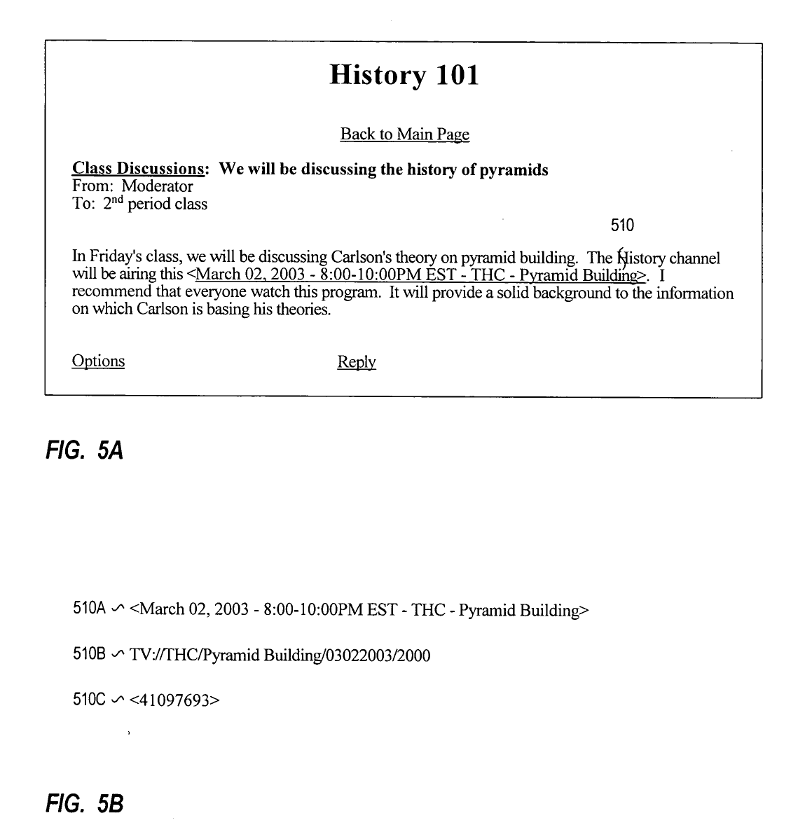

FIG. 5A is an illustration of an exemplary page for a chat room as described above. Discussions in a chat room like that represented in FIG. 5A may involve any topic of interest to the participants, including school topics, current events and general technology, or may focus on television and CMD-specific topics such as how to best use CMD features, technical and social issues related to CMDs, and programs of interest. A user can insert a program link 510 to a program that he or she found to be particularly appealing and which other users may select. Program link 510 is a text field that contains information sufficient to allow a CMD to find the program referred to by the program link and either tune to the program (if it happens to be running at the time the link is retrieved), or set the CMD (in this case assumed to include PVR functionality) to buffer the program, or record the program if the program is scheduled in the future.

Program link 510, in one embodiment, is generated manually by the user. In this embodiment, the user looks up the program information in a program listing or program guide and manually transcribes the appropriate information to a text entry field in the chat room screen. In an alternate embodiment, the user inserts a program link by selecting a field or block (with a mouse or other pointing device) in an Electronic Program Guide (EPG). In this embodiment, the system automatically transfers the necessary information from the EPG to the appropriate text entry field in the chat room. These embodiments are readily adapted to alternate community modalities, like instant messaging and email.

In the embodiment illustrated in FIG. 2, program link selection may be made on the television screen through remote control 112. In the embodiment illustrated in FIG. 3, the selection of program link 510 is made by using the computer's pointing device (mouse, or the like—not shown) on the displayed program link. In this embodiment, personal computer 300 sends a message through communications path 310 to personal video recorder 100. This message provides the program information to the PVR.

Program link 510 in FIG. 5 differs from the traditional hyperlink used in Web browsers, in that program link 510 is specifically designed to be used by, e.g., a personal video recorder 100A (either directly or indirectly, as described above) to identify a television program. Program link 510 may contain the same program information that is provided in the PVR electronic program guide, as discussed above. Creating the program links with the same information that is provided in the program guide simplifies the implementation of personal video recorder 100A. The selection of program link 510 by the PVR user sets up personal video recorder 100A to record, buffer, or play the selected program (depending on the time the program is to be presented and the time at which the program link is selected). This selection functions similarly to selecting a program from the program guide because the program link contains similar information to that provided in the program guide, and preferably uses the same format.

FIG. 5B illustrates several alternative formats for program link 510. Program link format 510A shows the complete description, as it would be stored in an Electronic Program Guide, including the presentation date and time, the network (THC, in the example), and the program title. Program link format 510B illustrates an alternative format that is similar to that of a URL (Universal Resource Locator) used to identify a location on the Internet. Program link format 510C uses a numeric code that uniquely determines the program, network, date and time. This code would be based on, for example, the Gemstar VCR+ codes published by most major newspapers and used to program VCRs. The program link formats presented in FIG. 5B are only examples, and those skilled in the art will recognize that many alternative formats may be used.

In an alternate embodiment, program links simply indicate the network, program title, and episode. When this program link is received by server 200 or personal video recorder 100, program guide data is searched to locate all broadcasts, rebroadcasts and reruns of the program indicated by the program link. These alternatives are provided to the program selection decision process to aid in selecting appropriate times for recording the selected program.

In another embodiment, the channel of personal video recorder 100A may be set based on chat room discussions. For example, the chat room screen may include an indication of a particular channel that is currently showing a program that is the subject of a current discussion. This indication consists of program link 510 that includes information such as the program title, time and channel. In this embodiment, this information is used by personal video recorder 100A to select a channel or program to view. A user is able to set his/her chat preferences to always tune to the channel being discussed in a chat room in which the user is participating. When a user logs onto a chat room that is set to program the user's personal video recorder 100A, the chat room sends the program information either directly to personal video recorder 100A (in the system illustrated in FIG. 2) or through a personal computer as illustrated in FIG. 3. In an alternate embodiment, personal video recorder 100A includes multiple tuners. In this embodiment, the channel being discussed may be recorded while the user continues to watch, or the PVR continues to record, a different channel. Additionally, a user can set personal video recorder 100A to automatically record both the program that is currently being discussed and the future episodes of the same program series.

Referring again to FIG. 4, when a PVR user, such as the user associated with PVR 100a joins a chat room, the user sets his or her preferences, which may include the user's Internet address and PVR information. The PVR information includes the type of PVR (necessary to program the PVR), the programming service that is used to provide television programs to the PVR, and information as to how to access the PVR. Access information includes how the PVR is connected to the network (through a telephone modem, a wireless modem, through a computer or through a Local Area Network). This information is part of the registration form required for membership in the chat room. When a user logs onto the chat room, the chat room server 200 can verify the user's identification and PVR information. During chat sessions, when a user posts a program link, the server stores the links in program link memory 202. This program link is then downloaded either automatically, or on request by the other users to their respective PVRs to enable the other users to record, buffer, or watch the program indicated by the program link. For example, a group interested in archeology may be planning on discussing theories of ancient pyramid building. The chat room moderator determines that a program of interest is going to be aired later in the week (e.g., Wednesday night). The chat room moderator logs onto the chat room prior to the air time of the program (e.g., Sunday), posts a program link that includes the program information, posts a discussion time (e.g., Thursday night) and sends an e-mail to all of the chat room members instructing them to log onto the chat room before the air time (e.g., Wednesday). Upon receiving the e-mail, a number of chat room members log onto the chat room and click on program link 510. The host web site automatically downloads the program information to each of the chat room members' personal video recorders, using their stored parameters. The chat room members' personal video recorders 100 receive the program information and use the program information to select recording of the desired program. The members are then able to view the desired program prior to the discussion time, making the discussion more interesting and informative.

Another example of a chat room group is a group of people interested in European travel. Members can log onto the chat room to find out information about traveling in Europe, or specific European countries. One member may start discussing a particular program detailing travel to various wine regions of Western Europe. This member may insert a program link 510 to the particular program into the message being posted. Other members of the chat room can select the program link, and after downloading have their PVRs automatically record the program. Then, at a later date, all of the members can “meet” to discuss the program. This can enable a more enlivened and interesting discussion, based on the viewing of the program.

In another embodiment, the chat room has a discussion leader or moderator, who has limited or total control over what all of the other members of the chat room are viewing, recording and/or buffering. The discussion leader sets future programming parameters (date/time/channel) in order to ensure that participants in a future chat have the desired programs available. After the programming is set by the discussion leader, the chat room sends the program links (in one of the manners previously described) to all of the chat room members' PVRs. PVRs, receive the program link and select a recording date, time and channel according the information provided in the program link.

As an example of this feature, CMD users can form a chat room about home improvement. In this chat room, members can discuss ideas on home improvement projects and give suggestions on how to perform various projects, including an ongoing discussion on home additions. The chat room moderator can post a program link containing program information for a specific series of programs on how to build a foundation, floor and walls for an addition to a house. When a member of the chat room logs onto the chat room to review the discussion, the program link automatically sets his or her personal video recorder 100A to record the upcoming episodes, or display and/or record the episode currently being received. This programming is performed in the manner previously discussed and differs from the previous example only in that the members of the chat room do not have to click on program link 510 to enable programming of their PVRs. The automatic recording of the suggested episodes enables the chat room members to discuss the ideas and suggestions shown in the particular viewed episode.

Yet another example of chat room directed recording is a cooking club chat room. A group of people who like a particular cooking show can join a chat room hosted by the cooking show. The producer of the cooking show may act as the chat room moderator. The producer edits the content of the chat room to include a page that contains a program link for a specific future episode of the show, and a list of ingredients necessary to cook along with the specific episode of the show. Members of the group are able to log onto the chat room and click on the program link 510, causing both the programming of their personal video recorder 100 to record the episode and causing printers (not shown) connected to the home network to print a shopping list of the ingredients needed to prepare the meal presented on the show. Alternatively, the shopping list may be sent to a Personal Digital Assistant (PDA), cellular phone or other mobile electronic device. The members are then able to purchase all of the ingredients necessary (if desired) and view the specific episode of the show at their leisure. If the user wants to cook along with the show, the user has the ability to pause or rewind the program in case the user is unable to keep up with the cooking process of the chef. Also, many cooking shows will show the preparation of an item that cooks for an extended period of time (e.g., hours). For example, the chef prepares a chicken to roast in the oven, gives roasting instructions and then removes a chicken from the oven that has already been roasted. Using a personal video recorder 100A would allow a cook to prepare a chicken, place the chicken in the oven, and turn off the cooking show while the chicken is roasting. When the chicken is fully cooked, the user then views the remainder of the cooking show in order to learn how to prepare the sauce for the chicken or how to carve the chicken.

Another variant of this concept is to have a chat room where a user just watches specific programs that are selected by another individual. For example, a history teacher may inform his or her students that a series of interesting programs are going to be broadcast, and that it would benefit all of the students of the class to view these particular programs. The history teacher then posts program link 510 onto a chat room that is dedicated to the history class, has limited membership to members of the history class, and is moderated by the history class teacher. Program link 510 is then posted either manually by the history teacher by inserting program link 510 or by use of the teacher's PVR. The history teacher can set his or her personal video recorder 100A to automatically insert program link 510 onto the history chat page every time the teacher selects the recording of a history program. The students can log onto the chat room and click on program link 510, resulting in the programming of their individual PVRs to record the history program being viewed by the teacher.

Alternatively, a CMD user could set his or her CMD to automatically post a program link to a web page, chat room or Blog, for every program that the user watches, buffers or records. Another user then logs onto this web page or chat room and views or records all of the programs that are posted on the page.

In another embodiment, the history teacher invites his or her students to join an on-line discussion (in a chat room, for example). The discussion includes viewing one or more programs or program segments during the discussion. In this scenario, the history teacher posts program links 510 to the chat room that immediately cause each student's CMD to tune to the appropriate channel. Program link 510 may be posted manually by the history teacher by inserting program link 510 into the chat transcript, or the history teacher can set his or her CMD to automatically insert program link 510 onto the history chat page every time the teacher tunes to a program of interest. In this scenario, the CMD needs only the capability to detect the program link and automatically tune to the correct channel. A program recording facility is not required.

In one embodiment, a security code is provided to prevent unauthorized users from sending links to unwanted programs. Additionally, a program rating code can be included. The security code enables a user to prevent other users from selecting programming of CMD without entering the security code. The program rating code can be provided to provide protection from programs having undesirable content, such as sexually explicit material, graphic violence or profanity. A parental setting can be provided that prevents recording, buffering or viewing of programs that contain unwanted content. Parents can set CMD to disable recording or viewing of any program that gets a rating higher than TV-13 without entering a password. This allows children use of the chat function because parents do not have to worry about the content of the programs that may be viewed by selection of program link 510. This parental control is similar in nature but not limited to, the functionality embodied in the “V-chip” currently installed in conventional televisions.

Chat rooms can have ad hoc or continuing membership. In one embodiment, posting to the chat room is controlled by the chat room moderator. The chat room can be set so that only the moderator is able to post links. Conversely, the chat room can be set so that any member is able to post links. The chat room moderator has the capability to prevent barred members from posting to the site and to prevent programs of questionable subject matter from being posted.

A CMD such as a PVR 100A can also be equipped with e-mail functionality, or connected to a PC e-mail client 300. While viewing a program, or a preview for a specific episode of a program, a user can send an e-mail notice to one or more people on his or her mailing list announcing the airing of the specific episode of the program. The e-mail can be sent the same way traditional e-mail is presently sent, i.e., a POP 3 server, an IMAP server or any other known server. A user can either designate individuals for each e-mail or send an e-mail to a specific group, consisting of specific e-mail addresses for specific individuals. For example, a teacher can designate all of his or her students under the group “class” and the teacher can e-mail the entire class by selecting “class” or e-mail only individual students. On receipt of this email, the recipient's personal video recorder 100A parses the message and determines if the message contains a properly formatted program announcement. If a properly formatted program announcement is found, either personal video recorder 100A is programmed to record the specific program specified in the announcement, or the announcement influences the decision process for what gets recorded by personal video recorder 100. The decision process takes into account the entirety of specific programs that are currently parsed in personal video recorder 100A to be recorded.

In one embodiment, a user designates the “priority level” of specific senders based on the similarities of viewing habits between the user and the sender. For example, the user designates person A, who has a large number of interests similar to those of the user, with a high priority level and person B, who has fewer interests similar to those of the user, with a lower priority level. E-mails received from person A receive more weight than e-mails from user B. In the scenario where a user receives an e-mail from user A and an e-mail from user B, both indicating the recording of specific programs that occur at the same time, personal video recorder 100A will automatically record the program indicated in the e-mail sent by user A.

In one embodiment, the “priority level” of individual users is set automatically by another user's CMD. This level is set by comparing both the programs viewed and program recorded by various PVR users. Users who have a history of watching or recording similar programs are assigned high priority levels. Users who have more dissimilar viewing and recording histories are assigned lower priority levels. The priority level is particularly useful in determining the programming of a PVR when a recording conflict occurs.

PVRs have a limited number of channels that can be recorded at the same time. Conventional PVRs are able to record only one or two channels simultaneously, and conflicts occur when the PVR is programmed to record or buffer more programs than the PVR can receive and process at once (e.g., two or three programs). When more programs have been scheduled to record simultaneously than the PVR can handle, the priority level designations can be used to determine which program(s) to parse for recording. If a user who has a PVR that can record two channels simultaneously receives programming instructions to record three specific programs that air at approximately the same time (or have overlapping air times), the “priority level” for each program is can, for example, be checked by personal video recorder 100. For example, a program may have four (or more) priority levels. Level 4 indicates that the program was selected directly by the user. Level 3 indicates that the program was sent to the user by an individual having high priority level assigned (as explained above) or from a chat room moderator. Level 2 indicates that a program was sent to the user by an individual who has a lower priority level. Level 1 indicates that the program was selected by the PVR using the user's stored viewing habits (as described earlier). Upon receiving the coded instructions to record the three programs having similar air times, personal video recorder 100 checks the priority level of all three programs and records (or buffers) the two programs having the highest priority level. If two or more programs have the same priority level, personal video recorder 100 can either record (or buffer) the programs based upon the order in which the commands were received or based upon the users instructions. Personal video recorder 100A prompts the user with an indication of the recording conflict and with instructions to select which of the conflicting programs to record. The user designates which of the programs to record either by using remote control 112 or by using the control panel of personal video recorder 100A. Personal video recorder 100A then records the specific program designated by the user. However, if the user does not designate which of the conflicting programs to record, personal video recorder 100A can automatically select which of the conflicting programs to record based upon the order in which the command was received, utilizing the oldest command first.

The four priority levels indicated above are for exemplary purposes only, and any desired number of levels can be set. Furthermore, the levels need not be discrete levels but can be continuous levels. The greater the number of levels that are used, the better personal video recorder 100A is able is to properly record (or buffer) the more desirable programs. Also, multiple factors can be used to set the levels, such as assigning a higher priority level to a program that is suggested by multiple users than to a program that is suggested by only one other user. Furthermore, a user can get suggestions from multiple sources including chat rooms, e-mails, or electronic journals, and is able to assign a priority level for each specific source. Upon receiving program instructions (i.e., program name, channel, date and time) to record, personal video recorder 100A checks the priority level assigned to the source and whether or not the instruction was received from multiple sources.

In another embodiment, a user could form a “buddy list”, including individuals who have interests similar to the user. Members of the buddy list can send e-mails indicating suggestions for future programs to record to the users personal video recorder 100A. The programs are automatically added to the PVR's parsed list of programs to record and are recorded upon airing. Additionally, an e-mail can be sent to the users e-mail account, indicating that a “buddy” set personal video recorder 100 to record a future program. Only individuals on the buddy list have the ability to set another PVR to record.

In another embodiment, a user programs an address book in his or her CMD. The address book can be programmed with individuals, groups of associated individuals, or a combination of both. The address book function can also be employed by the user to automatically e-mail selected groups or individuals when the user is viewing a program of particular interest. For example, a user is a member of an association and has programmed his or her CMD with an e-mail group including the other members of the association. While the user views a program of particular interest to the association, the user's CMD automatically e-mails the programmed group of e-mail addresses that the viewed program should be viewed, buffered or recorded. The e-mail is sent either directly to the members' CMDs or to their connected PC e-mail client.

A user can designate “program types”, such that designation of a program type automatically sends an e-mail to users interested in the category selected. For example, a user in a history club could designate a program as “history”, such designation automatically causing the user's CMD to e-mail the program information to the other members of the history club. This designation feature simplifies the process necessary to inform selected individuals of desired programs to view.

A user can also email a “play list” or “record list” which can enable the recipient's PVR to effectively synchronize its storage to the sender's configuration.

Internet Web Logs (Blogs)

Blogs (Web Logs) are a popular, fast-growing phenomenon on the Internet where individuals (professionals as well as nonprofessionals) publish (usually for public view) timely insights, feelings, observations, and other thoughts. Blogs may also include discussion threads similar to a bulletin board or news group.

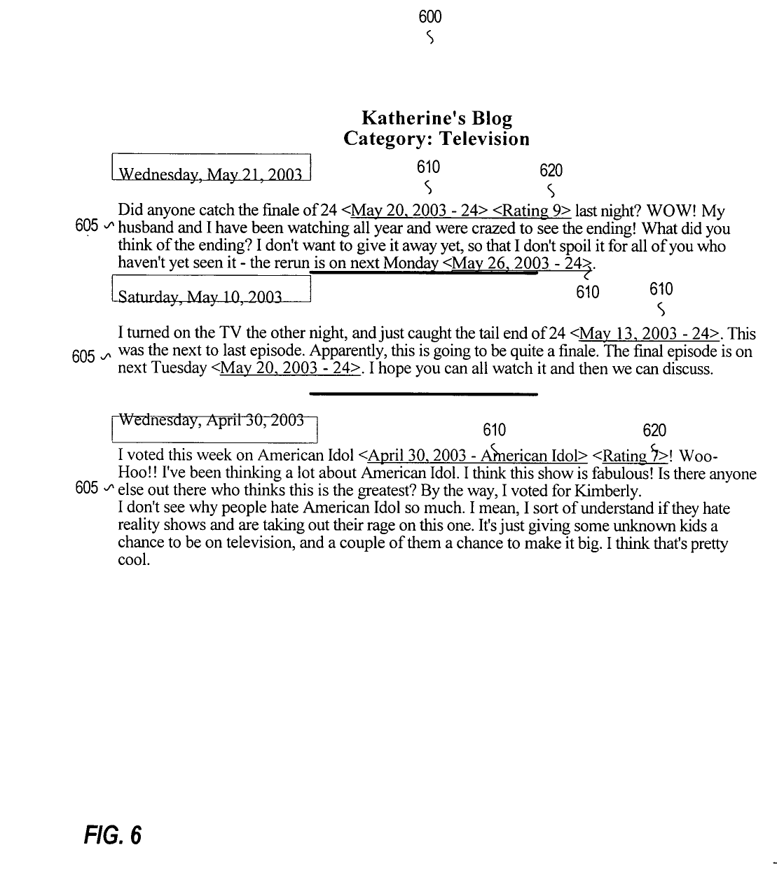

FIG. 6 illustrates a PVR blog 600 which is based on the concept of a conventional blog, but focuses on issues and topics associated with PVR use and television watching in general. The PVR blog 600 includes additional functionality that enables users to share PVR settings and programs to watch and record. Specifically, this capability allows PVR users to create, annotate, and “publish” a journal of television shows that they have viewed or recorded. Also, PVR blog 600 enables a user to create a live, personal program guide that can be used to program other users' PVRs. Currently, many episodes of a program are repeated at a later time, enabling a different PVR user who reads or follows a user's blog, to program his or her PVR to record the episodes discussed in the blog. Furthermore, a user can create “virtual” channels that other users can emulate, e.g., set their PVRs to record everything that is recommended by a local newspaper's TV critic, a national critic, or some other reviewer that they respect and has similar tastes, based upon a published blog.

Blog entries include machine readable program recommendations 610 and ratings 620 that are be used by personal video recorder 100A to influence its decision to record these programs.

The CMD can also be used to enhance the blog experience by providing to the user during blog entry creation program metadata and information about, and links to, related programs (based on its program guide database).

FIG. 6 shows a sequence of blog entries that illustrate several of the concepts incorporated in one embodiment of the invention. Blog 600 includes Entries 605 that are discussions of several television programs. In each blog entry, specific show references 610 and ratings 620 are coded to allow the CMD to find the appropriate show by comparing the reference information, which may include the date, time, channel, number, etc. to a program guide listing stored within, e.g., a PVR, and, based on the ratings and other criteria, decide whether or not to record the specified show. The rating codes are used by personal video recorder 100 to determine whether or not to record a program. If there is a conflict in recording schedule, a program having a low rating would not be recorded.

Blog 600 can be used by a user to control personal video recorder 100A. Selecting a program link of show information 610 in the Blog 600 automatically sets personal video recorder 100 to record or buffer the program indicated.

Many current PVRs allow the user to select a program to record by selecting a program entry from a menu. This program entry is encoded with both date/time information and the channel number or frequency. The PVR reads the selected entry and uses the date/time information and channel number or frequency to set the recording mode. Furthermore, the user has other recording options available when setting the recording time, such as starting the recording a few minutes early and extending the recording duration. The program link 610 of show information may include all of the information provided for a program in the selection menu. The user can also be provided with recording options, including changing the time to start recording and/or the time to stop recording.

Links 610 can be used in many other on-line modalities, including chat rooms, and in e-mails sent to or from various CMD users. A user may also send information from a remote terminal having Internet access to an e-mail recipient or a group of e-mail recipients (i.e., buddy list members). The remote terminal includes, but is not limited to, a laptop computer, a personal digital assistant (PDA), a cellular phone having internet access, or a personal computer.

In an alternate embodiment, the centralized server 200 is used to learn about group preferences and to access blogs, e-mail, or other web sites containing recommendation lists. When multiple sets of recommendations for each program are available, the server processes the recommendations to produce a refined set of priority levels for each specific program. The server can compare both the number of times a specific program is referenced and the rating 620 provided for each program. That is, if a program is only referenced a few times and rated lowly, server 200 does not forward the program information to other users' PVRs. If a program is referenced often and highly rated, the program is determined to be of common interest, and server 200 sends instructions to other users' PVRs to record the program. It will be obvious to one skilled in the art that many other forms and modes of processing recommendation data are possible. The embodiments described herein represent only a sample of the processing modes possible.

Although exemplary embodiments of the invention have been described with regard to a PVR, any digital recording device could be used with the present invention. This includes, but is not limited to, a personal computer, a DVD recorder and a Personal Audio Recorder (PAR). PARs work in much the same way as PVRs, but are used to record audio programs, such as from demodulated FM or AM signals.

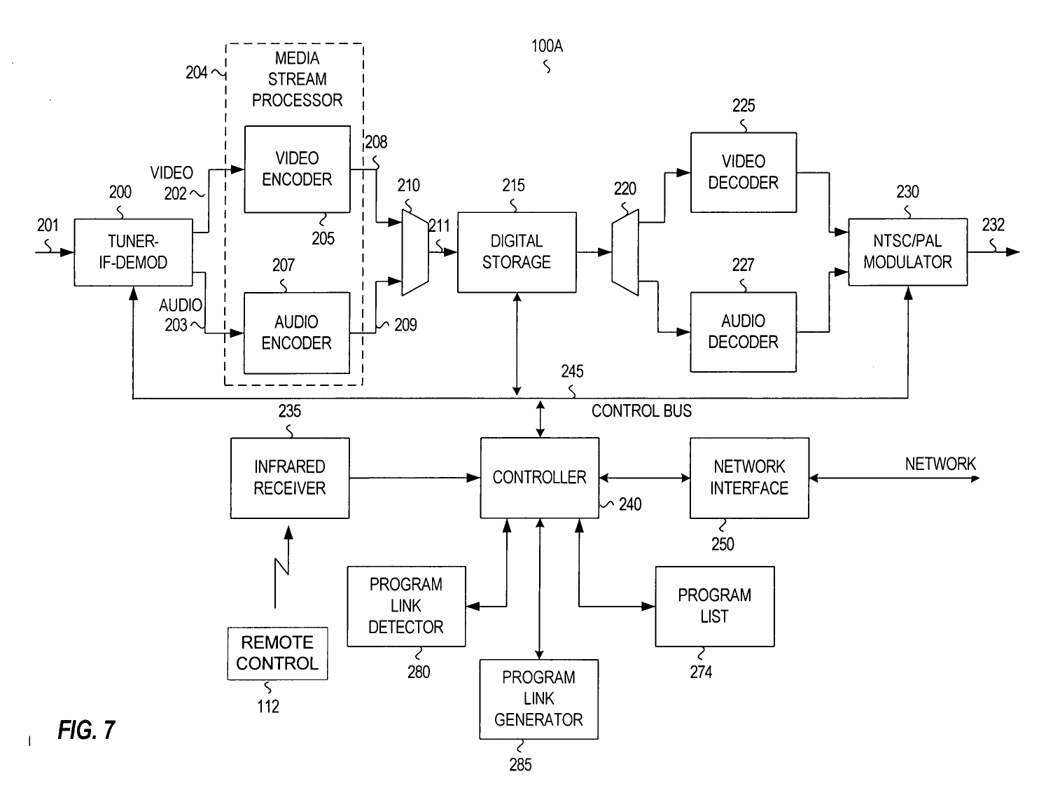

FIG. 7 is a simplified functional block diagram of Personal Video Recorder 100. The particular PVR illustrated in FIG. 7 is for use with analog television broadcasts (over-the-air or CATV, for example). The antenna/cable feed 201 is input to Tuner-IF-Demod 200. Tuner-IF-Demod 200 combines the functionality of tuner, intermediate frequency (IF) processor, and demodulator. (When we refer, in this specification, to a “tuner”, we are typically referring to the Tuner-IF-Demod combination.) These functions serve to tune the selected channel, filter and mix the selected channel to baseband, and demodulate the received signal into video signal 202 and audio signal 203. The channel is selected by the user through an IR (infrared) remote control (not shown) through Infrared Receiver 235 and Controller 240. Controller 240 programs the channel in Tuner-IF-Demod 200 through Control Bus 245.

Video signal 202 and audio signal 203 are processed by Media Stream Processor 204, which includes Video Encoder 205 and Audio Encoder 207. Video Encoder 205 digitizes (converts from analog form into digital form) and compresses video signal 202. Video Encoder 205 may use one of the many video compression algorithms such as those included in the standards commonly known as MPEG-1, MPEG-2, or MPEG-4, or a proprietary algorithm. Audio Encoder 207 digitizes and compresses audio signal 203. Audio Encoder 207 may use one of the many audio compression algorithms such as those included in the standards commonly known as MPEG-1 (including the algorithm commonly called MP3), MPEG-2, or MPEG-4, or another algorithm. Video Encoder 205 and Audio Encoder 207 may also encrypt the media steams to protect them from unauthorized copying. The digitized video and audio signals 208 and 209 are multiplexed in multiplexer 210 and the multiplexed signal 211 is stored in a file on Digital Storage 215 under the control of Controller 240 through Control Bus 245. Digital Storage 215 may be any fixed or removable mass storage device, including a hard disk drive, an optical disk drive, flash memory, etc.

Playback comprises retrieving of a desired media file from Digital Storage 215, and demultiplexing the retrieved signals in demultiplexer 220. The demultiplexed video and audio signals are decoded by Video Decoder 225 and Audio Decoder 227. Video Decoder 225 and Audio Decoder 227 use the appropriate decompression algorithms based on those used in Video Encoder 205 and Audio Encoder 207. Video Decoder 225 and Audio Decoder 227 may also decrypt the media signals if they were encrypted during the encoding process. The outputs of Video Decoder 225 and Audio Decoder 227 are converted to a form that is appropriate for display on Television 115 by NTSC/PAL Modulator 230. The output signals 232 of NTSC/PAL Modulator 230 may include an RF modulated composite video and audio signal as well as separate video and audio signals. Separate video signals may include a baseband composite video signal, an S-Video signal, and a component video signal. Audio signals may include line level analog mono or stereo audio and S/PDIF digital audio signals.

Controller 240 is responsible for managing all of the functions of Personal Video Recorder 100A and is also responsible for managing the files on Digital Storage 215. Included in the management of the files is the monitoring of free storage space, removal of unused or unneeded files, and prioritization of storage operations. Controller 240 is also responsible for acquiring, formatting and displaying an Electronic Program Guide (EPG) on television 115. Controller 240 may acquire the data required for the EPG from information carried on the broadcast signal or by downloading data through Network Interface 250 as discussed above. The Network Interface 250 is implemented either through a telephone modem, or as a direct or indirect Internet connection as illustrated in FIG. 2.

The EPG displays a listing of current and upcoming programs on all of the available channels. The user navigates the EPG, searches for programs, and selects programs to view or record by using an IR remote control 260 through Infrared Receiver 235.

Referring again to FIG. 7, Digital Storage 215 has a read/write bandwidth that is sufficient, at a minimum, to effectively support simultaneous read and write operations. This allows a user, for example, to watch a previously recorded program while another program is being recoded.

The PVR 100A also includes a program list 274 which is generated by the controller and includes an identification of all the programs to be recorded. The program list 274 includes programs that have been manually selected by the user, programs that have been automatically selected by the PVR, and programs recommended by other users as described in the embodiments above. When a user wishes to recommend a program to one or more other users, he/she identifies a specific program from this list, the controller 240 retrieves the information about the program from the program list 274, generates the program link using program link generator 285 and makes the program link available to the user by sending the program link directly to the other users or to the server 200. The server 200 reviews or parses messages from users and determines if any of them include a program link. If a program link is found, it is stored in program link memory 202. From this memory, the program links are available for downloading by the other users, as discussed above.

When a user downloads a program link, the link is sent to the program link detector 280. The link is decoded and sent to controller 240. Controller 240 then reviews the program link and uses the information contained therein to update its program list 274.

The controller 240 also performs the other functions described above. For example, in some instances, instead of just a single program link, a set of links may be downloaded. The controller 240 then updates the program list with either all the programs identified by the links, or just the programs identified by the user. For this latter function, the controller or the PC 300 present the list of links with associated programs to the user so that the user can determine what should be included in the program list. If the links also include recommendations or ratings, the user may use this information in making his selection. Alternatively, the controller 240 can select automatically which programs from the list of links are to be included in the program list based on the recommendations or the ratings.

The controller can also initiate requests to other users or to server 200 for lists of links.

In some instances the program link may include a priority code as well. The controller takes this priority code into account when updating the program list.

In another embodiment, a recommending user's CMD automatically acquires information specifying when a program mentioned in that user's recommendation will be rebroadcast, and inserts an appropriate link into the electronic communication which contains the recommendation.

In yet another embodiment, a central server automatically acquires information specifying when a program recommended in a user's electronic communication will be rebroadcast, and inserts an appropriate link into the electronic communication which contains the recommendation.

In yet another embodiment, a recommending user's CMD acquires information specifying when a program originally mentioned in that users electronic communication will be rebroadcast, subsequent to the original recommendation, and initiates an electronic communication to the user community containing a link to the rebroadcast of the recommended program.

In yet another embodiment, a central server acquires information specifying when a program originally mentioned in a user's electronic communication will be rebroadcast, subsequent to the original recommendation, and initiates an electronic communication to that same user containing a link to the rebroadcast of the recommended program.

The many features and advantages of the invention are apparent from the detailed specification. Thus, the appended claims are intended to cover all such features and advantages of the invention which fall within the true spirit and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

1. A method of enabling a community of users to view the same programs, the method comprising:
transmitting a reference identifying a program recommended by a first user to one or more users of the community;
receiving an electronic communication by a device associated with a second user, said electronic communication including said reference, said device being operable to selectively show said program to the second user.

2. The method of claim 1, further comprising the step of recording said program by a PVR.

3. The method of claim 1 further comprising distributing said information to a plurality of users, each user having a program list listing programs to be viewed and/or recorded with a CMD, and updating said program list using said reference by including said reference in said program lists.

4. The method of claim 1, wherein the electronic communication consists of an e-mail sent by a CMD.

5. The method of claim 1, wherein the electronic communication consists of an e-mail sent by a peripheral e-mail client server connected to a CMD.

6. The method of claim 1, wherein the electronic communication consists of transmission of a program link posted on an electronic publishing site.

7. The method of claim 6, wherein the electronic publishing site is a blog.

8. The method of claim 1, wherein the electronic communication includes a rating code.

9. The method of claim 1, wherein the electronic communication includes a priority code.

10. The method of claim 9, wherein the priority code is used to determine operation of the CMD.

11. The method of claim 1 further comprising sending a plurality of references in sequence and wherein said device shows the programs associated with said references.

12. The method of claim 11 wherein said first user has a first device operated by said first user to watch the programs in sequence and the device of the second user is synchronized to show the programs in sequence substantially at the same time.

13. A method of sharing programs by a community of users, each user being associated with a networked CMD, with each networked CMD being in communication with the other CMDs, the method comprising:
designating a recommended program by a first user;
generating an electronic communication by the networked CMD associated with said first user, said electronic communication including a reference identifying said recommended program;
transmitting said electronic communication by said networked CMD on the shared network;
receiving said electronic communication by the networked CMD associated with a second user; and
showing said program by said second CMD to the second user.

14. The method of claim 13 further comprising providing selection means with the networked CMD associated with the second user, said selection means being operated by said second user to selectively watch said program or watch another program.

15. The method of claim 13 further comprising publishing said electronic communication to a plurality of users.

16. The method of claim 13 wherein at least the second CMD is a PVR, further comprising recording said program using said PVR.

17. A method for sharing a plurality of program links on a plurality of networked CMDs, the method comprising:
publishing a list of program links on an electronic publishing site, each program link identifying a program to be broadcast;
downloading said list at one CMD; and
updating a program list at said CMD to include at least one program from said list of programs, said program list identifying programs to be viewed or recorded by said one CMD.

18. The method of claim 17 further comprising uploading said list of program links to said electronic publishing site.

19. The method of claim 17 wherein said electronic publishing site is an electronic journal.

20. The method of claim 17 wherein said list of program links includes recommendations about the programs associated with said program links.

21. The method of claim 17 wherein said list of program links includes ratings related to the programs associated with said program links.

22. The method of claim 21, wherein the rating code is used to determine whether the program may be recorded.

23. The method of claim 21, wherein the rating code includes parental control of viewing content.

24. A networked CMD for communally viewing programs by several users, the networked CMD comprising:
an input receiving an electronic communication from the network, said electronic communication including a program link identifying a program to be broadcast;
a tuning circuit; and
a controller that utilizes the program link to selectively cause said tuning circuit to be tuned to a channel associated with said program link.

25. The networked of claim 24, wherein the networked CMD is a PVR and said controller causes the PVR to selectively record signals from the tuned channel at a specific time and stop recording at a specific time.

26. The networked CMD of claim 24, wherein the electronic communication consists of an e-mail sent by another CMD.

27. The networked CMD of claim 24, wherein the electronic communication consists of an e-mail sent by a peripheral email client server connected to another CMD.

28. The networked CMD of claim 24, wherein the electronic communication consists of a program link posted on an electronic publishing site.

29. The networked CMD of claim 28, wherein the electronic publishing site is a blog.

30. The networked CMD of claim 24, wherein the electronic communication includes a rating code.

31. The networked CMD of claim 24, wherein the electronic communication includes a priority code.

32. The networked CMD of claim 31, wherein the priority code is used to determine operation of the CMD.

33. The networked CMD of claim 24, wherein the electronic communication includes a security code to prevent unauthorized access to the networked CMD.

34. A networked CMD for sharing program links among several users, the networked CMD comprising:
an interface for retrieving a published list of program links from an electronic publishing site; and
a controller using the list of published program links as a designated recording list for recording programs by the networked CMD.

35. The networked CMD of claim 34, wherein the published list of links is an electronic journal.

36. The networked CMD of claim 34, wherein the published list of links is a published programming recommendation.

37. The networked CMD of claim 34, wherein the published list includes a rating code.

38. The networked CMD of claim 37, wherein the rating code is used to determine whether the program may be recorded.

39. The networked CMD of claim 38, wherein the rating code includes parental control of viewing content.

40. A network for sharing program links comprising:
a server connected by a distributed communication network; and
a plurality of CMDs coupled to said distributed communication network, each of said CMDs receiving from said server a program link and updating a program list using said program link.

41. The network of claim 40, wherein said server hosts an electronic publishing site, said electronic site being used to publish said program link.

42. The network of claim 41 wherein said electronic site includes a rating code associated with the program link and used by said CMDs to determine if a program is desirable for viewing.

43. The network of claim 41, wherein the electronic publishing site is an electronic journal.

44. The network of claim 41, wherein said server is associated with a memory storing a list of program links.

45. The network of claim 41, wherein the electronic publishing site is a blog.

46. The network of claim 41, wherein the electronic publishing site is an electronic journal.
